(19) United States
(12) Patent Application Publication
(10) Pub. No.: US 2009/0254890 A1
(43) Pub. Date: Oct. 8, 2009

(54) APPARATUS AND METHOD FOR GENERATING INSTALL-LESS SOFTWARE FROM INSTALLATION PACKAGE OF SOFTWARE

(75) Inventors: Sung-Joo KANG, Daejeon (KR); Won-Young KIM, Daejeon (KR); Wonhyuk CHOI, Daejeon (KR); Wan CHOI, Daejeon (KR)

Correspondence Address: AMPACC LAW GROUP, 3500 188th St. SW, Lynnwood, WA, 98037, US

(73) Assignee: Electronics and Telecommunications Research Institute, Daejeon (KR)

(21) Appl. No.: 12/416,842

(22) Filed: Apr. 1, 2009

(30) Foreign Application Priority Data
Apr. 4, 2008 (KR) 10-2008-0031809
Jun. 24, 2008 (KR) 10-2008-0059591

(51) Int. Cl. G06F 9/45

(52) U.S. Cl. 717/136

(57) ABSTRACT

Disclosed is a system and method for completely converting software into a form that can be used without an installation process by using an operating system and a converted software generating module which are disposed at a remote place. The software converting system for generating a converted software executable without being installed from an installation package of the target software includes: a clean operating system without software installation information for the target software; an installation module for installing the target software in the clean operating system by executing the installation package; a converted software generating module for generating the converted software for the target software by comparing the clean operating system before and after the installation of the target software; and a system communication module for receiving the installation package and transmitting the generated converted software to the user terminal.

### CROSS-REFERENCES TO RELATED APPLICATIONS

The present invention claims priority of Korean Patent Application Nos. 10-2008-0031809 and 10-2008-0059591, filed on Apr. 4, 2008, and Jun. 24, 2008, respectively, which are incorporated herein by reference.

### BACKGROUND OF THE INVENTION

1. Field of the Invention

The present invention relates to a system, terminal, and method for converting software; and, more particularly, to a system and method for completely converting software into a form that can be used without an installation process by using an operating system and a converted software generating module which are disposed at a remote place.

2. Description of Related Art

When a user wants to use a target software in a computer, the user installs the target software in the computer from a compact disc (CD) storing an installation package for the target software or the user downloads the installation package for the target software from the Internet and installs the target software by executing the installation package. Package-based software can be used only after it is installed in a user computer, such as a personal computer (PC) and a laptop, through execution of an installation package.

For example, package-based software is software installed through Installer in a Windows-based system of the Microsoft and it is software installed through Redhat Package Manager (RPM) in a Linux-based system. This method, however, is uncomfortable because a user has to install the target software in every computer to be used. Even though the target software is used with low utility frequency, it should be installed in a computer of the user. Therefore, disc resources are consumed wastefully, and the use of the target software is limited because the target software can be used only in a computer with the target software installed therein.

To overcome the above-described problems, U.S. Pat. No. 6,324,690 filed by the Intel Company discloses a technology of distributing, installing, and collecting software through a network. To be specific, an administrative server installs and collects software in and from a user computer at a predetermined time through a network.

However, the technology of the U.S. Pat. No. 6,324,690 requires a target software to be installed in all administrative servers. Thus, work is performed in orientation of an administrator and since there is a change in the operating system of a user computer, the operating system of a user computer becomes less stable. Also, although the target software is normally installed through the network, the software execution environment may not be matched with the configuration environment of the user computer. Therefore, there is no guarantee that the target software operates normally in the user computer.

Another technology for overcoming the above-described problems is Korean Patent No. 734387 filed by the SoftonNet Company. The technology of Korean Patent No. 734387, known as virtualization technology through software repacking, is an advanced one from that of U.S. Pat. No. 6,324,690. Korean Patent No. 734387 discloses a technology of converting a target software into a form available for immediate use without such processes as distribution, installation and collection, disposing the target software in a streaming server, and streaming the target software on a computer of a user through a network so that the user can use the target software immediately.

In other words, according to Korean Patent No. 734387, a steaming server repacks and stores binary data generated when a target software is installed, and a user computer receives the binary data, which correspond to a needed portion of the target software, from the streaming server and configures an environment where the target software can be executed. Through the process, it is possible to execute the target software without changing the operating system of the user computer.

Using a streaming server just as in the Korean Patent No. 734387 requires a procedure of repacking a target software. For such repacking process, Korean Patent No. 506069, also filed by the SoftonNet Company, suggests a system and method for repacking a target software for streaming. To be specific, according to Korean Patent No. 506069, a target software is received and a minimum installation specification required for the target software is configured.

Subsequently, scan images before and after the installation of the target software are generated to be compared to thereby generate metaimages corresponding to the comparison result. Then, repacked software is generated based on the metaimages and uploaded to a streaming server. The application software repacking system of Korean Patent No. 506069 includes an input unit for receiving a software file to be repacked, a metaimage and minimum installation specification configuration unit for configuring a minimum installation specification required for the target software based on the software file inputted through the input unit and generating metaimages, and a repacked application software file generating and uploading unit for generating a repacked software file based on the generated metaimages and uploading the repacked software file to a streaming server.

The three conventional technologies, which are U.S. Pat. No. 6,324,690, Korean Patent No. 734387, and Korean Patent No. 506069, require a process of installing a target software at least once in an operating system during the conversion or repacking procedure. Also, when a target software to be converted is already installed in the operating system, it is not reinstalled, which makes it impossible to convert the target software.

Although a user attempts to delete the pre-installed software for conversion, software installation information is not completely deleted through software deletion in many cases. Since the software installation information remains in the operating system, there is a skip in the software installation process, and since a conversion result is generated through comparison before and after the installation, the skipped software installation information is not included in the conversion result, which is problematic.

Also, although the target software to be converted has never been installed before, if there is another software using a module in common with the target software to be converted already installed, the common module is not included in the conversion of the target software.

For example, when a common module (x) is used for a first software (A) already installed and a second software (B) to be converted and the common module (x) is already installed while the first software (A) was installed, the installation of the common module (x) is skipped during the installation of the second software (B) because it is already installed. Therefore, the common module (x) is excluded from the conversion of the second software (B) and the conversion result does not include the common module (x). This is the shortcoming of the above-described three technologies, which are U.S. Pat. No. 6,324,690, Korean Patent No. 734387, and Korean Patent No. 506069.

Meanwhile, according to the technologies of Korean Patent No. 734387 and Korean Patent No. 506069, one subject converts a target software through an application software repacking system and uploads the converted software onto a streaming server and a plurality of users download the streaming to use the converted software. Accordingly, a subject who performs software conversion may differ from a subject who executes the converted software. Therefore, a user not authorized with the license or utility right of the target software may execute the target software and it may be difficult to set up different software configuration according to the preference of a user.

### SUMMARY OF THE INVENTION

An embodiment of the present invention is directed to a method for converting a target software to generate a converted software executable without an installation process and preventing incomplete conversion of the target software that may be caused by software installation information of the target software to be converted.

Another embodiment of the present invention is directed to providing a converted software without an installation process through a software conversion system employing a clean operating system (OS), which has no software installation information on a target software to be converted.

Another embodiment of the present invention is directed to converting a target software in a system which is not a user computer to thereby produce a converted software of the target software and providing a terminal service so that an actual owner of the target software having an installation package and license converts and uses the target software.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided a system for converting a target software to generate a converted software executable without being installed from an installation package of the target software, which includes: a clean operating system (OS) without software installation information for the target software; an installation module for installing the target software in the clean operating system by executing the installation package; a converted software generating module for generating the converted software for the target software by comparing the clean operating system before the installation of the target software with the clean operating system after the installation of the target software; and a system communication module for receiving the installation package and transmitting the generated converted software to the user terminal.

In accordance with another aspect of the present invention, there is provided a user terminal for receiving a software conversion service from a software converting system, which includes: a terminal communication module for transmitting an installation package of a target software to the software converting system so that the software converting system generates a converted software executable without being installed from the installation package of the target software and receiving the converted software from the software converting system.

In accordance with another aspect of the present invention, there is provided a method for converting a target software to generate a converted software executable without being installed from an installation package of the target software, which includes: receiving the installation package; installing the target software in a clean operating system, which does not have software installation information for the target software, by executing the installation package; generating a converted software for the target software by comparing the clean operating system before with the clean operating system after the installation; and transmitting the generated converted software to a user terminal.

### BRIEF DESCRIPTION OF THE DRAWINGS

FIG. 1 is a block view showing a software converting system 10 and a user terminal 20 in accordance with an embodiment of the present invention.

FIG. 2 is a flowchart describing a software converting method in accordance with an embodiment of the present invention.

FIG. 3 is a detailed flowchart illustrating a converted software generation process of step S104 shown in FIG. 2.

FIG. 4 illustrates how the software converting system 10 and the user terminal 20 operate in accordance with an embodiment of the present invention.

FIG. 5 describes software conversion applied when an interactive installation service is provided to a user in accordance with another embodiment of the present invention.

FIG. 6 illustrates software conversion applied when an installation package is received through recognition of a disc drive 51 in accordance with yet another embodiment of the present invention.

FIG. 7 describes software conversion applied when a clean operating system (OS) is maintained through a virtual machine module 62 in accordance with still another embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter. When it is considered that detailed description on a prior art may obscure a point of the present inventions the description will not be provided. Hereafter, specific embodiments of the present invention will be described in detail with reference to the accompanying drawings.

“Installation” signifies an operation or procedure of adding a relevant file and configuration to a computer for a user to use software, or a result thereof. In particular, in this specification, “installation” refers to the following general procedure of installing software. Generally, software is provided to users in a compressed form devised for distribution, which is called an installation package.

An installation package is of a form where information related to software is compressed and stored. For a user to use a target software, the user should execute an installation file. This procedure is carried out as the user executes an installation file in a computer where the user means to use the target software. This procedure is a general installation of a target software and this is the meaning of a term “installation” mentioned in this specification.

While the target software is installed, a test or check on whether the target software is appropriate to a system of the computer may be performed. The computer is provided with a file and configuration needed to make the target software accurately operate. The file and the configuration provided during the installation include a common module, which is a shared program file, a non-shared program file, a folder/directory, a registry, which is needed when a computer adopts Microsoft's Windows operating system, a configuration file, an environment variable, link/short-cut and so forth.

An “installation package” is a computer program for setting up software in a computer. Installation packages are largely divided into Microsoft's Windows-based Installer and Unix-based Package Management System according to an operating system. The two have somewhat different characteristics but they all are installation packages. Examples of installation packages are Microsoft Installer (MSI) used for Windows-based systems and Redhat Package Manager (RPM) used for Linux-based systems. However, the present invention is not limited to the two installation packages.

“Target software” refers to a specific software that a user wants to use among softwares. Herein, software includes an application program, a plug-in, a hardware driver, and all computer programs of diverse forms. Software is generally stored in a memory device such as a hard disc as a binary format file through an installation process. When a user executes a target software, the binary file is loaded onto a memory of a computer and the target software runs.

“Converted software” is software of a specific form that can be executed without installation. Converted software may be generated from an installation package of software according to an embodiment of the present invention, and it is software immediately executable as it is.

“Software installation information” stands for all files and configurations formed in an operating system during the installation of software. Software installation information includes a common module of software, a non-shared program file, a folder/directory, a registry, which is needed when a computer adopts Microsoft's Windows operating system, a configuration file, an environment variable, link/short-cut and so forth. Software installation information “for specific software” refers to a relevant file and configuration formed during the installation of the specific software, and it includes a common module that the specific software uses.

“Clean operating system (OS)” refers to an operating system in the state of having no software installation information for a specific software. Clean operating system does not always have to maintain a state that it does not have any software installation information for software. Clean operating system signifies a state that an operating system does not have software installation information for a target software before the software conversion of the present invention is performed, to be more specific, before the target software is installed for software conversion. As described above, a clean operating system should not include software installation information for the target software but it may include software installation information for software other than the target software and information for operation of the operating system.

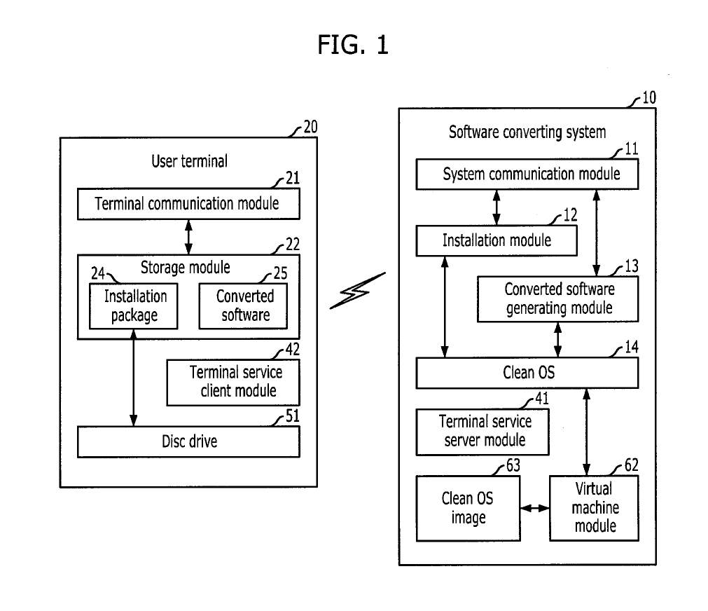

FIG. 1 is a block view showing a software converting system 10 and a user terminal 20 in accordance with an embodiment of the present invention. The software converting system 10 and the user terminal 20 operates in connection to each other through a network.

The software converting system 10 and the user terminal 20 may be formed of any type of a computer that can be connected to a network.

“Computer” refers to an apparatus or a system that can receive a structuralized input, process the input according to predetermined rules, and output a process result thereof. Examples of the computer include a personal computer (PC), a laptop computer, a super computer, a mainframe, which is a large computer for processing diverse data, a mini-computer, a workstation, a large computer, a Personal Digital Assistant (PDA), a smart phone, a cellular phone, a mobile computer, a wearable PC, an interactive television, a server, a client, an application-specific hardware, a computer equipped with one or more processors, a distributed computing system, a system of more than two computers connected through a network and transmitting/receiving information to/from each other.

“Network” refers to all kinds of communication facility that connects more than two computers through cable or wirelessly and enables them to communication with each other and a connection through the communication facility. Examples of the communication facility include cables, such as Unshielded Twisted-Pair (UTP) Local Area Network (LAN) cable, Shielded Twisted-Pair (STP) LAN cable, direct cable, cross cable, serial cable, IEEE1394 cable, Universal Serial Bus (USB) cable, optical cable, and BOX cable, LAN card, hub, switch, wired/wireless Internet router, wireless access point (AP), transceiver, and so forth. Connection through the communication facility includes not only semi-permanent connection such as connection through optical cable, but also temporary connection through a communication access link such as phone access, access through a modem, serial communication access, wireless Internet connection and so forth. A network mentioned in this patent specification includes a Personal Area Network (PAN), a LAN, a Metropolitan Area Network (MAN), a Wide Area Network (WAN), a wireless LAN, and home network.

A software converting system 10 includes a system communication module 11, an installation module 12, a converted software generating module 13, a clean operating system 14, a terminal service server module 41, a virtual machine module 62, and a clean operating system image 63.

The system communication module 11 is set up to connect the software converting system 10 to the user terminal 20 through a network, and transmits/receives an installation package of the target software and a converted software through the connection. The system communication module 11 can transmit the installation package and an installation command to the installation module 12. Also, the system communication module 11 sends a driving command to the converted software generating module 13 or receives a converted software from the converted software generating module 13.

The installation module 12 executes the installation package transmitted from the system communication module 11 and installs a target software in the clean operating system 14. The installation operation of the installation module 12 may be performed automatically or it may be performed upon receipt of a user command transmitted from the system communication module 11.

The converted software generating module 13 may monitor the clean operating system 14. When the installation module 12 installs a target software in the clean operating system 14, the converted software generating module 13 generates a converted software based on a result of monitoring the clean operating system 14 before and after the installation of the target software.

In short, the converted software generating module 13 extracts a converted portion by managing a memory change of the clean operating system 14 before and after the installation of the target software and creates the converted software from the converted portion. The detailed operation of the converted software generating module 13 is the same as or similar to the operation of the application software repacking system of the Korean Patent Nos. 734,387 and 506,069, which are described in the Description of Related Art section of this specification. The converted software generating module 13 may transmit the generated converted software to the system communication module 11.

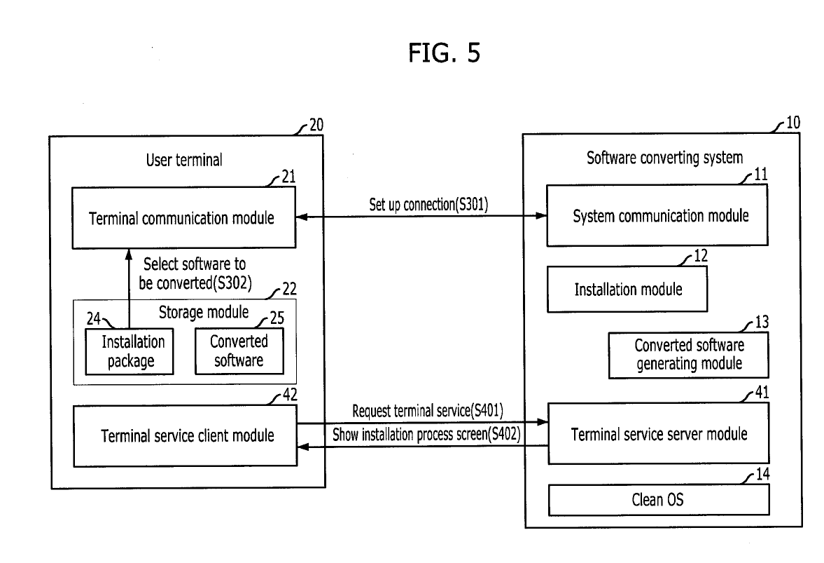

Meanwhile, the software converting system 10 may include the terminal service server module 41. The terminal service server module 41 may be connected to a terminal service client module 42 of the user terminal 20 to provide an interactive installation service to a user. The “interactive installation service” refers to a process that a user directly executes input of license, approval of working right, and installation of software during the installation process. The terminal service server module 41 makes it possible to the interactive installation service. The terminal service server module 41 receives an input from the user terminal 20 or transmits installation process information needed by a user to the user terminal 20. The operation of the terminal service server module 41 will be described in detail with reference to FIG. 5.

The software converting system 10 may include the virtual machine module 62 and the clean operating system image 63. The software converting system 10 goes through a process of installing the target software in an operating system for software conversion. Herein, the operating system should be free of software installation information for the target software. The virtual machine module 62 and the clean operating system image 63 provide a method of making the operating system where the target software is to be installed into the clean operating system 14. The operations of the virtual machine module 62 and the clean operating system image 63 will be described in detail with reference to FIG. 8.

The user terminal 20 includes a terminal communication module 21, a storage module 22, a terminal service client module 42, and a disc drive 51. Also, the storage module 22 includes an installation package 24 and a converted software 25.

The terminal communication module 21 sets up the user terminal 20 to be connected to the software converting system 10 through a network. The installation package 24 and the converted software 25 are transmitted/received through the connection. The operation of the software converting system 10 may require a command from a user and in this case, the terminal communication module 21 transmits the command from the user to the software converting system 10. Also, the terminal communication module 21 may receive the installation package 24 from the storage module 22 or it may transmit the converted software 25 to the storage module 22.

The storage module 22 stores the installation package 24 for installing the target software and the converted software 25 generated in the software converting system 10. The storage module 22 transmits the installation package 24 to the terminal communication module 21 or receives the converted software 25 from the terminal communication module 21. The user can use the target software by not installing the converted software 25 in the storage module 22 and directly executing the converted software 25. A result produced by executing the converted software 25 is the target software which is the same as a result produced by executing the software installed from the installation package through a general installation process.

Meanwhile, the user terminal 20 may include the terminal service client module 42, and the terminal service client module 42 is connected to the terminal service server module 41 of the software converting system 10 to provide the user with an interactive installation service. The terminal service client module 42 transmits an input from the user to the software converting system 10, or it receives installation process information needed by the user from the software converting system 10. The operation of the terminal service client module 42 will be described in detail with reference to FIG. 5.

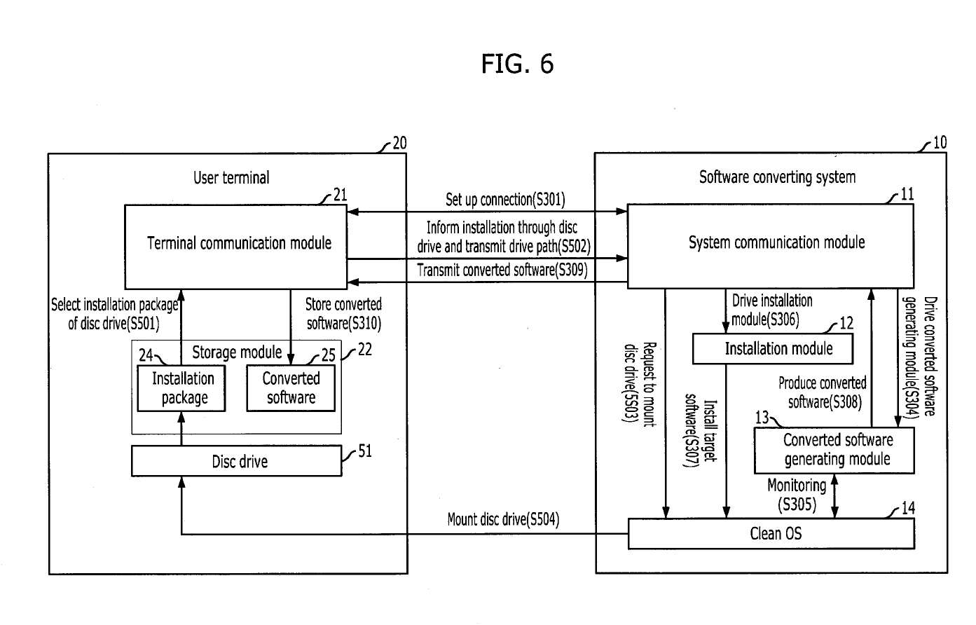

The user terminal 20 may include the disc drive 51. The disc drive 51 can read the installation package 24 stored in a storage medium (not shown) and transmits the read installation package 24 to the terminal communication module 21 or the storage module 22. The software converting system 10 may recognize the disc drive 51 as a drive. The operation of the disc drive 51 will be described in detail with reference to FIG. 6.

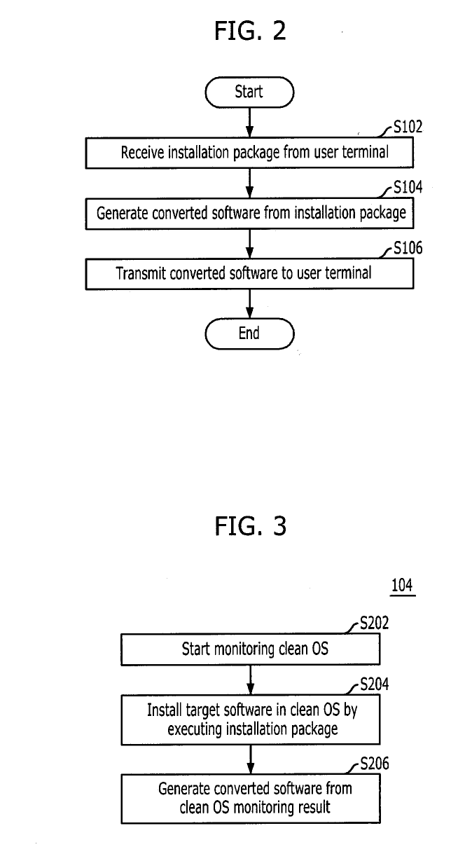

FIG. 2 is a flowchart describing a software converting method in accordance with an embodiment of the present invention. The software converting method of the present invention will be described hereafter with reference to FIGS. 1 and 2.

First, in step S102, a software converting system 10 receives an installation package 24 from a user terminal 20. The installation package 24 may be received through the connection between the system communication module 11 and the terminal communication module 21, or it may be received as a disc drive 51 reads the installation package 24 stored in a storage medium and the software converting system 10 recognizes the disc drive 51 of the user terminal 20.

In step S104, the software converting system 10 generates a converted software 25 based on the received installation package 24. The generated converted software 25 is of a form that can be executed without an installation process by a user, and the user can use a target software by executing the converted software 25.

When the converted software 25 is generated, the software converting system 10 transmits the converted software 25 to the user terminal 20 in step S106, thereby terminating a software conversion process. The user terminal 20 may store the converted software 25 it received in a storage module 22.

FIG. 3 is a detailed flowchart illustrating a converted software generation process of step S104 shown in FIG. 2. Referring to FIG. 1, the generation of the converted software 25, which is performed in the step S104, will be described hereafter.

When the software converting system 10 receives the installation package 24 from the user terminal 20 in the step S102, a converted software generating module 13 begins monitoring a clean operating system 14 in step s202. The monitoring of the clean operating system 14 is to observe the state of a memory of the clean operating system 14. The monitoring may be performed continuously or temporarily.

In step S204, an installation module 12 installs the target software in the clean operating system 14. The installation process is performed in a typical software installation process.

When the installation of the target software is completed in the step S204, the converted software generating module 13 generates the converted software 25 based on the result of monitoring the clean operating system 14. In short, the converted software generating module 13 manages variation in a memory of the clean operating system 14 before and after the installation of the target software, extracts a converted portion, and forms the converted software 25 based on the converted portion.

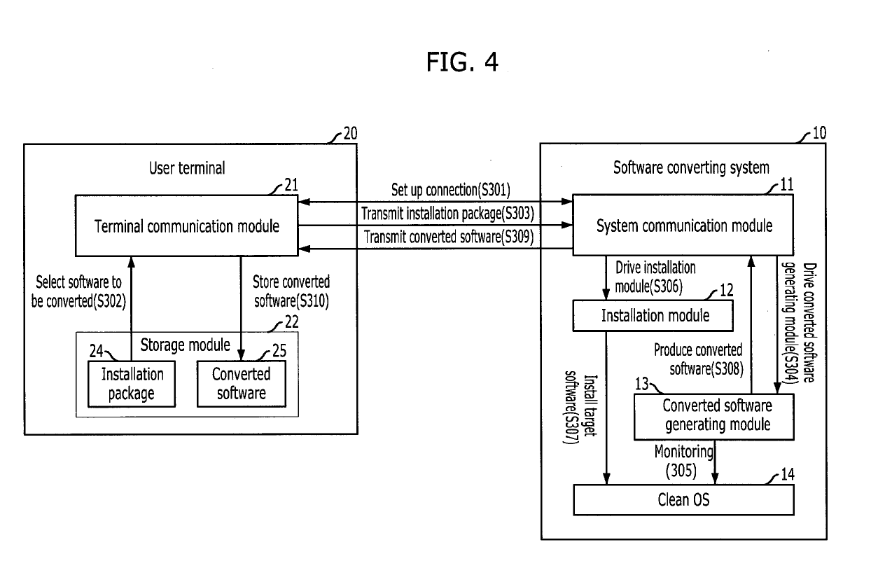

FIG. 4 illustrates how the software converting system 10 and the user terminal 20 operate in accordance with an embodiment of the present invention.

First, in step S301, a user connects the user terminal 20 to the software converting system 10 through the terminal communication module 21. When the user selects software to be converted in step S302, an installation package 24 corresponding to the selected software is transmitted to the terminal communication module 21. In step S303, the terminal communication module 21 transmits the received installation package 24 to the system communication module 11 of the software converting system 10.

When the system communication module 11 of the software converting system 10 drives the converted software generating module 13 in step S304, the converted software generating module 13 begins monitoring a clean operating system 14 in step S305. In step S306, the system communication module 11 transmits the installation package 24 to an installation module 12 and drives the installation module 12.

In step S307, the installation module 12 installs the target software in the clean operating system 14 by using the installation package 24. When the installation of the target software is completed in the step S307, a converted software generating module 13 extracts a change in a memory before and after the installation from the result of monitoring the clean operating system 14, which is performed in the step S305. In step S308, the converted software generating module 13 completes the generation of the converted software 25 based on the memory change extraction and transmits the converted software 25 to the system communication module 11.

In step S309, the system communication module 11 transmits the received converted software 25 to a terminal communication module 21 of the user terminal 20. The terminal communication module 21 forwards it to a storage module 22. In this way, the user can execute the converted software 25 stored in the storage module 22.

Hereafter, the method of executing the converted software, which is suggested in the present invention, will be described in comparison with a general method of a user executing software. In general, a user executes an installation package 24 of a target software downloaded from the Internet or an installation package 24 stored in a storage medium such as a compact disc (CD) to install the target software, and then execute the target software.

If the user wants to use the target software in another computer, the user has to download the installation package 24 again into the desired computer or transfer the installation package 24 to the desired computer by using a storage medium, re-install the target software, and use it, which is inconvenient. However, if the user uses the converted software of the present invention, the user can simply use the target software in another computer without going through the re-installation process and the user may also conveniently carry out the software.

Meanwhile, it is described before that the conventional technologies U.S. Pat. No. 6,324,690, Korea Patent No. 734,387, and Korea Patent No. 506,069 incompletely convert a target software due to the presence of software installation information for the target software. The present invention solves the problem of the conventional technologies by separately having a software converting system with a clean operating system and performing all the software conversion process in the software converting system.

FIG. 5 describes software conversion applied when an interactive installation service is provided to a user in accordance with another embodiment of the present invention. Hereafter, the operations of a software converting system 10 and a user terminal 20 will be described with reference to FIGS. 4 and 5.

The software converting system 10 and the user terminal 20 provide a user with an interactive installation service upon a request from the user or according to a system. For the software conversion of the present invention, the software converting system 10 installs target software. Herein, the user may be required to input a license number or make an agreement for using the target software. Besides, the user may be given to select software configuration according to his preference. To provide such interactive installation service, the software converting system 10 may provide a terminal service to the user terminal 20.

“Terminal service” refers to a service provided between more than two computers connected through a network. The terminal service signifies a function or tool capable of making one computer access to and manage another computer connected to the network in a remote place. Examples of commercial tools providing the terminal service include Remote Desktop or Terminal Service provided to Microsoft's Windows-based systems, Xmanager available for Linux-based systems, pcAnywhere of Symantec Corporation and so forth.

The software converting system 10 and the user terminal 20 may include a terminal service server module 41 and a terminal service client module 42, respectively, to provide the interactive installation service. First, the basic process of converting a target software is the same as described with reference to FIG. 4. That is, the software converting system 10 and the user terminal 20 are connected in the step S301, and the user selects the target software to be converted.

In step S401, the terminal service client module 42 requests the terminal service server module 41 for a terminal service. When the terminal service server module 41 accepts the terminal service request, in step S402, work information on the installation of the target software performed in the step S307 in the software converting system 10 is transmitted to the terminal service client module 42.

Since the work information may include an output screen interface of the target software installation as it is, the user can watch the screen in his user terminal 20 and perform such activities as inputting his license number, making an agreement, and selecting software configuration. What is inputted by the user is transmitted from the terminal service client module 42 to the terminal service server module 41. A series of subsequent procedures of the generation of a converted software and reception of the converted software in the user terminal 20 are the same as described with reference to FIG. 4.

FIG. 6 illustrates software conversion applied when an installation package is received through recognition of a disc drive 51 in accordance with yet another embodiment of the present invention. Operations between the software converting system 10 and the user terminal 20 according to the embodiment of the present invention will be described hereafter with reference to FIGS. 4 and 6.

“Disc drive” is an auxiliary memory device capable of recording or reading data in or from a storage medium. Disc drive may be called a disc driving device. Examples of the disc drive 51 includes a floppy disc drive (FDD), a hard disc drive (HDD), a compact disc (CD) drive, a Digital Versatile Disc (DVD) drive, a memory card reader, a Universal Serial Bus (USB) flash drive and so forth.

“Storage media” stand for all types of medium for storing computer-readable data. Examples of the storage media include a magnetic disc, an optical disc, a portable storage medium and so forth. Among the storage media, examples of the magnetic disc media include magnetic table, drum memory, floppy disc, hard disc, a magnetooptical disc and so forth. Examples of the optical disc include a laser disc (LD), a compact disc (CD), a mini disc (MD), DVD, a blue-ray disc (BD), a high-definition (HD) DVD. Each medium includes forms of Read Only Memory (ROM), recordable (R), rewritable (RW), disposable (D), and Random Access Memory (RAM). Examples of the portable storage media include a flash memory. Flash memory includes a USB flash memory type and a memory card type. Examples of the memory card type includes compact flash (CF), smart media (SM), memory stick (MS), multimedia card (MMC), secure digital (SD) and so forth.

The installation package of the target software may be stored in a storage medium such as CD and distributed. When a user uses the storage medium with the installation package stored therein, the user can obtain the installation package as the disc drive 51 in the user terminal 20 reads the storage medium.

The basic process of software conversion is as described with reference to FIG. 4. However, when the user selects the target software to be converted in the step S302, the installation package stored in a storage medium (not shown) read by the disc drive 51 is selected in step S501 instead of the installation package stored in the storage module 22. Information that the installation package is selected through the disc drive 51 is transmitted to the terminal communication module 21. In step S502, the terminal communication module 21 informs the system communication module 11 of the software converting system 10 of its intention to install the installation package through the disc drive 51 and transmits a route of the disc drive 51.

Subsequently, the system communication module 11 requests the clean operating system 14 to mount (or register) the disc drive 51 based on the received route of the disc drive 51. In step S504, the clean operating system 14 recognizes the disc drive 51 through the system communication module 11 and the terminal communication module 21 to access to the information read by the disc drive 51.

Since the software converting system 10 can make an access to the installation package read by the disc drive 51, software conversion is carried out by driving the installation module 12 and the converted software generating module 13. The subsequent procedures of transmitting the converted software 25 to the user terminal 20 in the step S309 and storing the converted software 25 in the step S310 are the same as described with reference to FIG. 4.

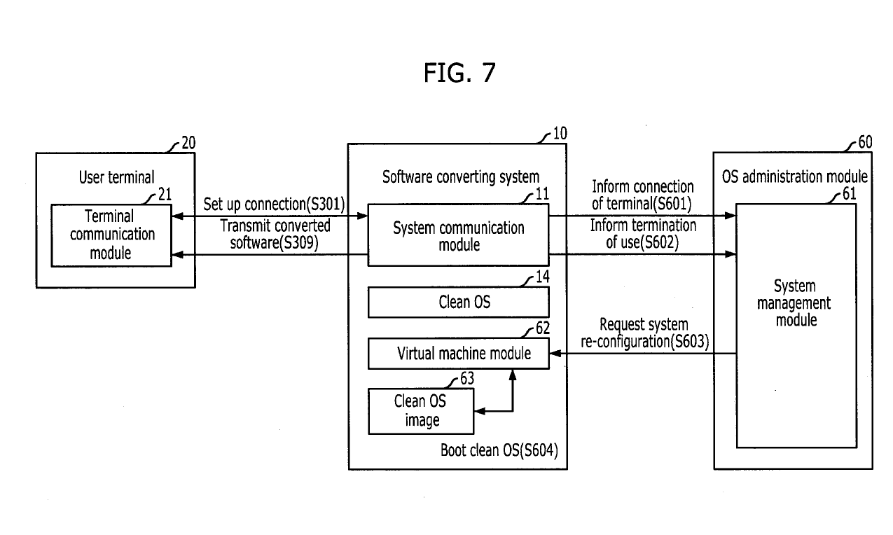

FIG. 7 describes software conversion applied when a clean operating system is maintained through a virtual machine module 62 in accordance with still another embodiment of the present invention. The operation between the software converting system 10 and the user terminal 20 will be described hereafter with reference to FIGS. 4 and 7.

The operating system of the software converting system 10 comes to have software installation information for the target software because it goes through a process of installing the target software during software conversion. Once the operating system has the software installation information, it is not a clean operating system any more. To execute software conversion again, the operating system of the software converting system 10 should return to the state where it does not have the software installation information.

Sometimes, however, it is not easy to completely remove the software installation information. In this case, an operating system in charge of managing the software converting system 10 may be used as the clean operating system 14, or a clean operating system image 63 may be loaded and used only for the software conversion, leaving the virtual machine module 62 behind. The clean operating system image 63 is maintained as it is all the time. Thus, when software conversion needs to be performed, what should be done is to load the clean operating system image 63 again.

Herein, the software converting system 10 may include the virtual machine module 62, the clean operating system image 63, and an operating system administration module 60 for managing the virtual machine module 62 and the clean operating system image 63. The operating system administration module 60 may be disposed inside or outside the software converting system 10 and it may further include a system management module 61.

In step S601, after the software converting system 10 is connected to the user terminal 20, the system communication module 11 informs the operating system administration module 60 that the connection is established. When the software converting system 10 completes the software conversion as described with reference to FIGS. 4 to 6, the system communication module 11 transmits the converted software 25 to the user terminal 20 in the step S309.

Subsequently, the system communication module 11 notifies the operating system administration module 60 that the software conversion work of the software converting system 10 is completed. Upon receipt of notification, the system management module 61 included in the operating system administration module 60 requests the virtual machine module 62 to re-establish the software converting system 10. Upon receipt of the re-establishment request, the virtual machine module 62 loads the clean operating system image 63 and reboots the operating system in step S604. This way, the software converting system 10 can completely perform software conversion again.

The above-described apparatus and system may be realized as software or a combination of softwares. When the above-described apparatus and system are realized in hardware, a module used for software conversion may be realized as at least one selected from the group consisting of an Application-Specific Integrated Circuit (ASIC), a digital signal processor (DSP), a digital signal processing device (DSPD), a Programmable Logic Device (PLD), a Field Programmable Gate Array (FPGA), a processor, a controller, a microcontroller, a microprocessor, an electronic unit designed to perform above-described functions, and a combination thereof. Software may be realized as a module executing the above-described functions. A software code may be stored in a memory unit and executed by a processor. The memory unit may be realized inside or outside the processor. In this case, the memory may be connected to a processor through diverse means.

Meanwhile, the method of the present invention described above may be programmed for a computer. Codes and code segments constituting the computer program may be easily inferred by a computer programmer of ordinary skill in the art to which the present invention pertains. The computer program may be stored in a computer-readable recording medium, i.e., data storage, and it may be read and executed by a computer to realize the method of the present invention. The recording medium includes all types of computer-readable recording media, that is, it includes not only tangible media such as CD and DVD, but also intangible media such as carrier wave.

As described above, the technology of the present invention can resolve a problem of the generation of an incompletely converted software, which may occur when a target software is converted in an operating system where the target software has been installed before, and relieve a user from a trouble of having to remove software installation information of the target software from the operating system for complete conversion of the target software by generating a converted software through a remote software converting system employing a clean operating system.

Also, the technology of the present invention makes it possible for an actual owner of a target software having an installation package and license to convert the target software through a terminal service.

Furthermore, according to the technology of the present invention, a converted software is not of a form that is installed in the operating system of a user but of a form that can be instantly usable. Therefore, the converted software can be easily distributed as long as the ownership lies on the user and the user can quickly use the software in various computers by executing the converted software.

The present invention may be applied to all computer softwares that are used after installation. In particular, it may be applied to a mobile office environment system or an individual software platform system.

While the present invention has been described with respect to the specific embodiments, it will be apparent to those skilled in the art that various changes and modifications may be made without departing from the spirit and scope of the invention as defined in the following claims.

What is claimed is:

1. A system for converting a target software to generate a converted software executable without being installed from an installation package of the target software, comprising:
a clean operating system (OS) without software installation information for the target software;
an installation module for installing the target software in the clean operating system by executing the installation package;
a converted software generating module for generating the converted software for the target software by comparing the clean operating system before the installation of the target software with the clean operating system after the installation of the target software; and
a system communication module for receiving the installation package and transmitting the generated converted software to the user terminal.

2. The system of claim 1, further comprising:
a terminal service server module for transmitting a working state of the installation module to the user terminal and receiving information or a command needed for the installation module to install the target software from the user terminal.

3. The system of claim 1, wherein the system communication module receives the installation package stored in a storage medium read by a disc drive as the user terminal receives information on the disc drive and recognizes the disc drive.

4. The system of any one of claims 1 to 3, wherein the software installation information includes at least one consisting of file data, installation record and registry information of the target software, and a common module shared by the target software and another software.

5. The system of any one of claims 1 to 3, further comprising:
a virtual machine module and a clean operating system image,
wherein since the virtual machine module loads the clean operating system image, the software installation information is removed from an operating system to thereby turn the operating system into the clean operating system.

6. A user terminal for receiving a software conversion service from a software converting system, comprising:
a terminal communication module for transmitting an installation package of a target software to the software converting system so that the software converting system generates a converted software executable without being installed from the installation package of the target software and receiving the converted software from the software converting system.

7. The user terminal of claim 6, further comprising:
a terminal service client module for transmitting information or a command needed for the software converting system to install the target software to the software converting system and receiving a working state of the installation of the target software.

8. The user terminal of claim 6, further comprising:
a disc drive for reading a storage medium with the installation package stored therein,
wherein the terminal communication module transmits the installation package stored in the storage medium to the software converting system by transmitting information on the disc drive to the software converting system and making the software converting system recognize the disc drive.

9. A method for converting a target software to generate a converted software executable without being installed from an installation package of the target software, comprising:
receiving the installation package;
installing the target software in a clean operating system, which does not have software installation information for the target software, by executing the installation package;
generating a converted software for the target software by comparing the clean operating system before with the clean operating system after the installation; and
transmitting the generated converted software to a user terminal.

10. The method of claim 9, further comprising:
providing a terminal service, which includes:
transmitting a working state of the installation process to the user terminal; and
receiving information or a command needed to install the target software in the installation process from the user terminal.

11. The method of claim 9, wherein said receiving the installation package includes:
receiving information on a disc drive mounted on the user terminal and recognizing the disc drive; and
receiving the installation package stored in a storage medium read by the disc drive.
